(19) United States
(12) Patent Application Publication
(10) Pub. No.: US 2009/0158884 A1
(43) Pub. Date: Jun. 25, 2009

(54) Positioning assembly for gripping tube of handlebar

(75) Inventors: Chang-Chin Kuo, Taichung Hsien (TW); Hsi-Kai Shih, Changhua County (TW)

Correspondence Address: CHARLES E. BAXLEY, ESQUIRE, 90 JOHN STREET, SUITE 309, NEW YORK, NY, 10038, US

(73) Assignees: Ming Hsing Leather Co., Ltd.; Propalm Industry Co., Ltd.

(21) Appl. No.: 12/004,147

(22) Filed: Dec. 20, 2007

(51) Int. Cl. B62K 21/26

(52) U.S. Cl. 74/551.9

(57) ABSTRACT

The present invention provides a positioning assembly for a gripping tube of a handlebar. The positioning assembly comprises a gripping tube sheathing the handlebar, wherein each of two ends of the gripping tube is positioned by a fastening ring, which has an annular shape, a slit, an outer ring periphery and an inner ring periphery. Therein, a prominence radially raised and two increased-thickness portions are provided on the inner ring periphery so that when the slit of the fastening ring is narrowed, the fastening ring can tightly embrace an outer surface of the handlebar with the prominence and the two increased-thickness portions.

### BACKGROUND OF THE INVENTION

1. Technical Field

The present invention relates to gripping tubes of handlebars, which are provided for users' comfortable gripping. More particularly, the present invention relates to a positioning assembly for positioning a gripping tube at a terminal of a handlebar of a bicycle so that when being positioned by the positioning assembly, the gripping tube is restricted from moving along an axial of the handlebar and is also restricted from rotating with respect to the handlebar.

2. Description of Related Art

U.S. Pat. No. 6,263,759 has disclosed a handlebar grip assembly, which can be removably attached to a handlebar. The grip assembly has an inner rigid shell with outwardly extending protrusions at each end, a pair of rigid clamps passing over the outwardly extending protrusions and tightening against the handlebar to hold the grip assembly in place, and a soft, flexible grip portion affixed to the outer surface of the inner rigid shell. The rigid clamp has a first end and a second end, wherein the first end is adjunct to the inner rigid shell and has receiving recesses for receiving the outwardly extending protrusions, while the second end has an inner surface entirely affixed to the outer surface of the handlebar. The rigid clamp further has a slit that can be expanded or narrowed by a tightening screw whereby the tightening of the screw reduces the width of the slit and forces the rigid clamp against the handlebar. Meanwhile, the receiving recesses and the protrusions prevent the inner rigid shell from rotating around the handlebar.

On the other hand, U.S. Pat. No. 6,035,742 has disclosed a multi-part handlebar grip, which comprises an engaging tube 16, an engaging grip 23, and clamps 29, 30. The engaging tube 16 has recesses 19 as receiving portions formed at an inner surface adjacent two ends thereof, and axially extending ribs 22 formed on an outer surface thereof. The grip 23 is molded with internal grooves 28 so that when the engaging grip 23 sheathes the outer surface of the engaging tube 16, the internal grooves 28 can receive the ribs 22. The clamps 29, 30 are each a circular member having a tightening slot and for being mounted onto each end of the engaging grip 23 with curved tabs 20 fitting within the recesses 19 of the engaging tube 16. The tightening slot can be adjusted by a screw so that inner surface of the clamp 29 or 30 can press a handlebar of a bicycle. Thereupon, in virtue of the mating between the curved tabs 20 and the recesses 19 and the mating between the ribs 22 and the grooves 28, the engaging tube 16 and the engaging grip 23 are prevented from turning with respect to the handlebar.

### SUMMARY OF THE INVENTION

The present invention provides a positioning assembly for a gripping tube of a handlebar. A gripping tube sheathes each of two ends of the handlebar, and each of two ends of the gripping tube is positioned by a fastening ring. Each of the two ends of the gripping tube has a first abutting member and a second abutting member that extend axially with respect to the gripping tube. The end of the gripping tube further comprises a first receiving portion and a second receiving portion separately formed on the end of the gripping tube and between the first abutting member and the second abutting member, wherein the second receiving portion is larger than the first receiving portion. The fastening ring has an annular shape, a slit, an outer ring periphery and an inner ring periphery. The inner ring periphery is eccentric with respect to the outer ring periphery. A prominence is radially raised at the inner ring periphery distantly aligned with the slit. Two increased-thickness portions are provided on the inner ring periphery at a first end and a second end of the fastening ring adjacent to the slit. The slit can be narrowed by a screw. When the fastening ring has the inner ring periphery thereof mounted onto the first abutting member and the second abutting member, the prominence is accommodated in the first receiving portion and the two increased-thickness portions face the second receiving portion.

It is the main objective of the present invention is to provide the positioning assembly wherein when the screw of the fastening ring is screwed tight, inner surfaces of the first abutting member and the second abutting member press an outer surface of the handlebar while the fastening ring has three portions, which are an inner surface of the increased-thickness portion at the first end of the fastening ring, an inner surface of the increased-thickness portion at the second end of the fastening ring, and an inner surface of the prominence, jointly pressing the outer surface of the handlebar. Thereupon, the gripping tube is positioned outside the handlebar by the fastening rings, so as to be prevented from shifting along an axis of the handlebar and be also prevented from rotating with respect to the handlebar.

As compared with the prior Patent U.S. Pat. No. 6,263,759, the progressive effects of the present invention are further manifest. The following explanation will be directed to FIG. 4 of the Patent U.S. Pat. No. 6,263,759. Two shell-protrusion-receiving recesses 30, 31 are such formed at a side of the rigid clamp 27 that the recesses are opposite and aligned mutually for receiving two protrusions 20, 20′ of the inner rigid shell 16. The opposite side of the rigid clamp 27 presses upon the handlebar. Therefore, it is learned that the rigid clamp 27 of the '759 Patent contact the entire periphery of the handlebar while the present implements “three portions” to press upon the outer surface of the handle bar. However, this does not means that the fastening ring of the present invention is inferior in binding the handlebar. Since the fastening ring of the present invention uses its inner ring periphery to embrace the first and the second abutting members, when the fastening ring is narrowed, a centripetal pressure can force the first and the second abutting members to press upon the handlebar. Hence, the gripping tube of the present invention also functions for pressing the handlebar. Besides, the first and the second abutting members press upon the handlebar just at positions between the prominence and the two increased-thickness (the three portions), respectively, so as to strengthen the pressing effect. Thus, the combination of fastening ring of the present invention and the gripping tube (the first and second abutting members) can also contact the entire periphery of the handlebar. Moreover, as compared with the '759 Patent, the disclosed positioning assemble contacts a larger area of the handlebar so the present invention is superior to the '759 Patent in the positioning effect. Besides, the inventor of the present invention is in the opinion that the protrusions 20, 20′ of the '759 Patent is incapable of positioning the handlebar because the shell-protrusion-receiving recesses 30, 31 are formed at the side, but not the inner ring periphery of the rigid clamp. Thus, when the rigid clamp of the '759 Patent is narrowed, the shell-protrusion-receiving recesses 30, 31 fail to provide an overall pressing force to the protrusions 20, 20′ so that the protrusions 20, 20′ can not press tightly upon the handlebar. As a result, the combination between the protrusions 20, 20′ and the shell-protrusion-receiving recesses 30, 31 can only restrict the grip from rotating around the handlebar.

It is another objective of the present invention to provide the positioning assembly wherein the fastening ring has a simplified configuration as compared with those disclosed in the prior Patents U.S. Pat. No. 6,263,759 and U.S. Pat. No. 6,035,742.

### BRIEF DESCRIPTION OF THE DRAWINGS

FIG. 1 is an exploded view of an end of a handlebar;

FIG. 2 is a perspective view of a positioning assembly for a gripping tube according to the present invention;

FIG. 3 is an end view of a gripping tube according to the present invention;

FIG. 4 is a plane view of a fastening ring according to the present invention;

FIG. 5 is a sectional view taken along Line 5-5 in FIG. 2; and

FIG. 6 is a sectional view taken along Line 6-6 in FIG. 5.

### DETAILED DESCRIPTION OF THE PREFERRED EMBODIMENT

As the drawings recited in the following embodiments are provided for illustrating the concept of the present invention as described above, it is to be understood that the deformation and displacement of the components in these drawings are made for better explanation and need not to be made in scale.

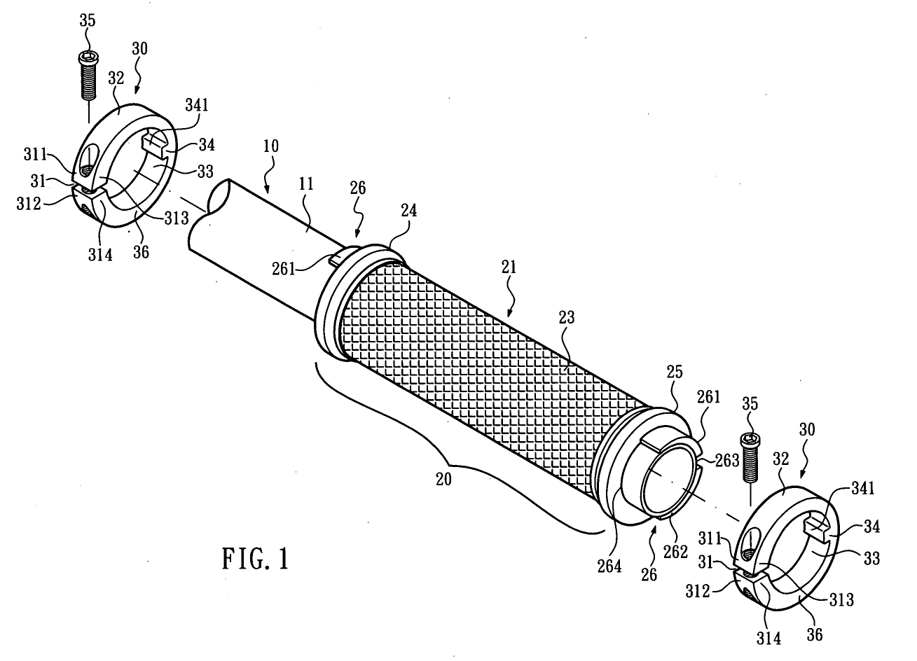

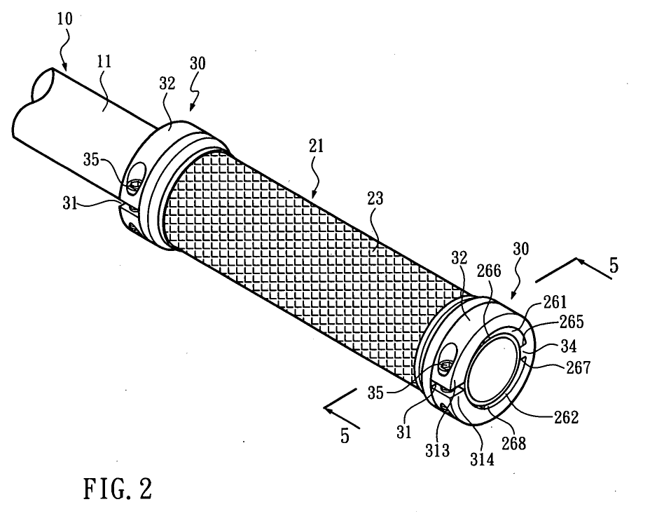

A gripping tube sheathes each of two ends of the handlebar of a bicycle so as to allow a user to grip and control the handlebar thereby. As shown in FIGS. 1 and 2, one of the ends of the handlebar 10 and a positioning assembly 20 of the present invention settled around the handlebar 10 are depicted. Therein, the positioning assembly 20 comprises a gripping tube 21 and a pair of fastening rings 30. The gripping tube 21 sheathes the handlebar 10 while the fastening rings 30 are combined with two ends of the gripping tube 21 and settled on the handlebar 10.

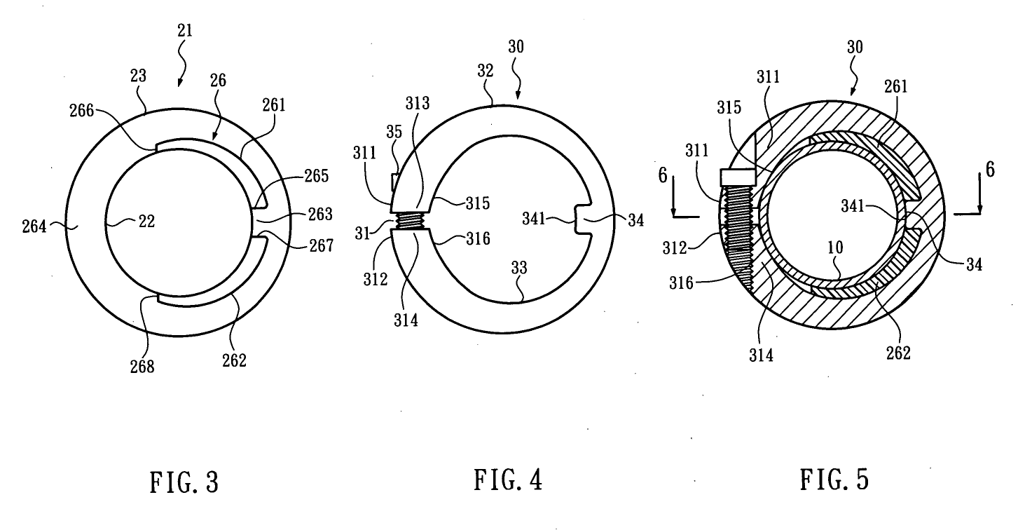

Referring to FIGS. 1 and 3, the gripping tube 21 has an inner surface 22 and an outer surface 23, each having a circular sectional shape. The outer surface 23 is formed with a rugged texture so as to enhance a friction during the user's gripping. The entire inner surface 22 contacts an outer surface 11 of the handlebar 10. The gripping tube 21 has a first end 24 and a second end 25 opposite to the first end 24. Each of the first end 24 and the second end 25 has a combining segment 26, which axially extends outward from the inner surface 22. According to the present embodiment, the combining segment 26 comprises a first abutting member 261, a second abutting member 262 and a first receiving portion 263 as well as a second receiving portion 264 separately formed between the first abutting member 261 and the second abutting member 262. The second receiving portion 264 is larger than the first receiving portion 263. Each of the first and second abutting members 261, 262 axially extends outward from the inner surface 22 of the gripping tub 21 and has a first end 265, 267 and a second end 266, 268. Besides, each of the first and second abutting members 261, 262 has a thickness gradually reduced from the first end 265, 267 toward the second end 266, 268. The first receiving portion 263 is formed between the two first ends 265, 267.

According to FIGS. 1 and 4, the fastening ring 30 has an annular shape, a slit 31, an outer ring periphery 32 and an inner ring periphery 33. A prominence 34 is radially raised at the inner ring periphery 33 distantly aligned with the slit 31. Two increased-thickness portions 313, 314 are provided on the inner ring periphery 33 at a first end 311 and a second end 312 adjacent to the slit 31. Further, the slit 31 can be narrowed by a screw 35.

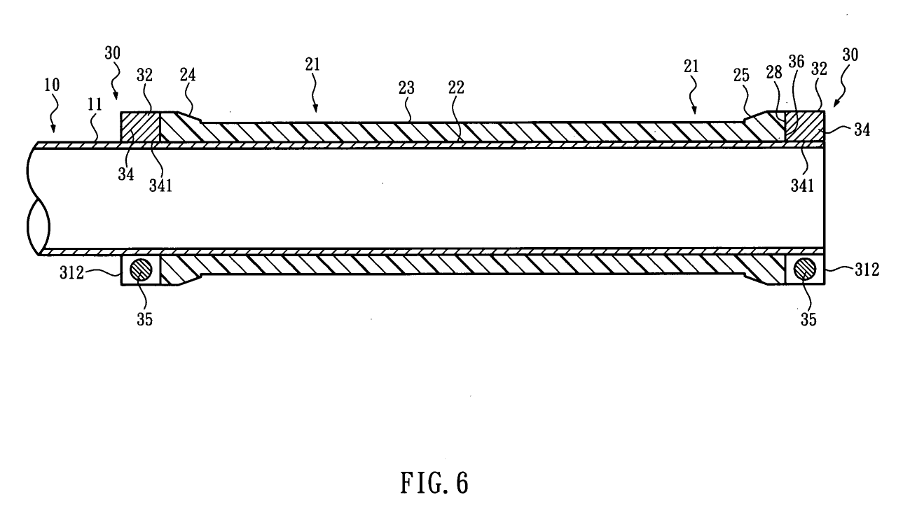

As shown in FIGS. 5 and 6, the gripping, tube 21 is mounted around the handlebar 10 while the fastening ring 30 is assembled around the combining segment 26 with a lateral ring surface 36 abutting an end 28 of the gripping tube 21 such that the prominence 34 is inlaid in the first receiving portion 263 while the first end 311 together with the second 312 are positioned in the second receiving portion 264. Then the fastening ring 30 and the combining segment 26 can press upon the outer surface of the handlebar 10 by screwing the screw 35 of the fastening ring 30 tight. In FIG. 5, the combination of the fastening ring 30, the combining segment 26 and the handlebar 10 is illustrated by a sectional view of the assembled components. When the screw 35 is screwed, a centripetal pressure is provided by the fastening ring 30 to force the inner surfaces of the first and the second abutting members 261, 262 to press upon the outer surface of the handlebar 10 and the fastening ring 30 has three portions, which are an inner surface 315 of the increased-thickness portion 313 at the first end 311 of the fastening ring 30, an inner surface 316 of the increased-thickness portion 314 at the second end 312 of the fastening ring 30, and an inner surface 341 of the prominence 34, jointly pressing the outer surface of the handlebar 10.

Through the aforementioned structure, the gripping tube 21 is positioned around the handlebar 10 by the fastening rings 30 so as to be prevented from shifting along an axis of the handlebar 10 and be also prevented from rotating with respect to the handlebar 10. Moreover, the fastening ring 30 of the present invention can be integrally formed and therefore has a simplified configuration as compared with those disclosed in the prior Patents U.S. Pat. No. 6,263,759 and U.S. Pat. No. 6,035,742.

Although a particular embodiment of the invention has been described in detail for purposes of illustration, it will be understood by one of ordinary skill in the art that numerous variations will be possible to the disclosed embodiments without going outside the scope of the invention as disclosed in Although a particular embodiment of the invention has been described in detail for purposes of illustration, it will be understood by one of ordinary skill in the art that numerous variations will be possible to the disclosed embodiments without going outside the scope of the invention as disclosed in

What is claimed is:

1. A positioning assembly for a gripping tube of a handlebar, comprising:
the gripping tube sheathing the handlebar, wherein each of two ends of the gripping tube is positioned by a fastening ring, which has an annular shape, a slit, an outer ring periphery and an inner ring periphery, in which a prominence radially raised and two increased-thickness portions are provided on the inner ring periphery so that when the slit of the fastening ring is narrowed, the fastening ring can tightly embrace an outer surface of the handlebar with the prominence and the two increased-thickness portions.

2. The positioning assembly of claim 1, wherein, the fastening ring is mounted around a combining segment at the end of the gripping tube, in which the combining segment comprises a first and second abutting members axially extending outward from the end of the gripping tube, and a first and second receiving portions formed separately at the end of the gripping tube and between the first and second abutting members, wherein the second receiving portion is larger than the first receiving portion.

3. The positioning assembly of claim 2, wherein, the prominence of the fastening ring is inlaid in the first receiving portion of the combining segment.

4. The positioning assembly of claim 3, wherein, the two increased-thickness portions of the fastening ring are positioned in the second receiving portion.

5. The positioning assembly of claim 2, wherein, each of the first and second abutting members has a first end and a second end opposite to the first end, and has a thickness gradually reduced from the first end toward the second end.

6. The positioning assembly of claim 5, wherein, the first receiving portion is formed between the two first ends.

7. The positioning assembly of claim 1, wherein, the prominence of the fastening ring is radially raised at the inner ring periphery and distantly aligned with the slit.

8. The positioning assembly of claim 6, wherein, the increased-thickness portions are provided on the inner ring periphery at a first end and a second end of the fastening ring adjacent to the slit.

9. The positioning assembly of claim 2, wherein, the first and second abutting members axially extend outward from an inner surface of the gripping tube so that when the slit of the fastening ring is narrowed, the first and second abutting members press upon the outer surface of the handlebar.
